(19) United States
(12) Patent Application Publication
(10) Pub. No.: US 2009/0116518 A1
(43) Pub. Date: May 7, 2009

(54) Multiplexing of optical beams using reversed laser scanning

(75) Inventors: C.Kumar N. Patel, Los Angeles, CA (US); Anadi Mukherjee, Los Angeles, CA (US); Manu Prasanna, Marina del Rey, CA (US)

Correspondence Address: Cislo & Thomas LLP, 1333 2nd Street, Suite #500, Santa Monica, CA, 90401-4110, US

(73) Assignee: Pranalytica, Inc.

(21) Appl. No.: 11/982,518

(22) Filed: Nov. 2, 2007

(51) Int. Cl. H01S 3/10; H01S 3/08

(52) U.S. Cl. 372/23; 372/101

(57) ABSTRACT

A high efficiency, low cost, nondispersive optical multiplexing arrangement for optical beams, used a technique denominated “Reverse Laser Scanning.” In the Reverse Laser Scanning operation, different laser beams angularly meet on the rotational axis of a galvanometer-mounted mirror or the like. Upon reflection from the mirror, each of the laser beams is propagated along one defined direction by appropriate angular positioning of the galvanometer mirror. The process enables several useful deployments, including multi-chemical detection using several lasers in the same sensor, remotely operated laser switching for medical surgery and diagnosis where multiple lasers may be used, and wavelength, code, and time division multiplexing in communication systems, among others.

### COPYRIGHT AUTHORIZATION

Portions of the disclosure of this patent document may contain material which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever. 37 C.F.R. § 1.71(d).

### BACKGROUND OF THE INVENTION

1. Field of the Invention

This invention relates to the multiplexing of optical, and preferably laser, beams.

2. Description of the Related Art

There is a growing need for and many advantages can be obtained by an efficient, high bandwidth, high optical power handling capacity, and cost effective laser and/or optical multiplexing device and method that can be used in several fields including chemical sensing, medical surgery, semiconductor manufacture, and metrology applications. Many of these applications are in the mid and long wave infrared (MWIR and LWIR) regions (wavelengths longer than l μm).

In-plane integrated optical multiplexing schemes used in communications industry are not appropriate for the above needs¹⁻⁶ because the long wavelength radiation needed for these applications cannot be handled using the optical materials used for the fabrication of such planar multiplexing schemes. High security optical communication demands adjustable “time-spread” between the channels. Optical multiplexing using dispersive optical elements such as gratings, bandpass filters, prisms etc., currently lacks bandwidth and entails optical losses.

Optical multiplexing of multiple lasers emitting very narrow lines but tunable over wide bandwidths is necessary for high sensitivity, high selectivity detection of chemical species⁷.

In laser surgery (e.g., tumor removal, eye, bone etc.), surgeons often require more than one laser beam wavelength (cw and/or pulsed) through a single fiber optic catheter for near-perfect and/or improved operation with high repeatability. Efficient multiplexing of laser beams from at least a wavelength spectrum such as from UV to visible to IR in an optical fiber cable that is remotely routed from a centrally-located laser room (very much like a server room for a network) could allow easy access of laser beams for different surgical operation rooms in the same hospital complex. This would reduce the need for multiple laser installations and maintenance.

Advanced laser diagnostics may also require more than one laser beam multiplexed into a single fiber-optic probe. Optical probe technology in semiconductor manufacturing and metrology could benefit from a highly-efficient and cost-effective optical multiplexing system.

Prior attempts have been made in the art with respect to laser systems (multiplexed and otherwise). Brief descriptions of some of such prior attempts are set forth below. While the descriptions are believed to be accurate, no admission is made by them regarding their subject matter which is solely defined by the patent or reference involved.

Aagano et al., U.S. Pat. No. 4,655,590 discloses a method of coalescing two or more laser beams and employs an optical merging element such as a polarization beam splitter to make the laser beams substantially merged into a single laser beam of multiplied power. In the merged laser beam, however, the original laser beams cannot easily be perfectly aligned with each other. In order to have the laser beams perfectly mingled or coalesced at the position where they are focused on an object to be processed or an original to be read out or a recording medium, the original laser beams substantially merged into a single laser beam are collimated so that the collimated laser beams may be directed to the same focusing position on the object. To collimate the original laser beams in the merged beam, a part of the merged beam is split out and passed through a converging lens to cause the original laser beams focused to points on a pinhole plate by use of a converging lens, and the directions of the original laser beams are corrected to make the laser beams focused to the same point on the pinhole plate or coincide with the pinhole. By making these laser beams coincide with the pinhole, these laser beams are consequently collimated so that they can be focused to the same point on said object, whereby the laser beams are coalesced in effect.

This Aagano et al. '590 patent describes polarization-dependent coupling of laser beams, i.e., using Glan-Thompson type polarizing cubes. In this scheme, only two orthogonally polarized beams can be coupled efficiently. Cascading the same process will couple out any additional beam. The Aagano et al. system depends on polarization of the individual beams and may put limits on the number of beams that could be used.

In U.S. Pat. No. 7,088,353 to Fujii et al., in order to provide a display device by which increasing of number of spatial light modulation elements and increasing of number of pixels can be suppressed, and high definition of a display image is easily realized, in the display device, a DMD is inclined with respect to a sub scanning direction by very small inclining-angle, and this inclining-angle is set in accordance with a scanning density of a light beam in a main scanning direction on the surface to be scanned.

The Fujii et al. '353 patent combines several beams into a single fiber. Single mode fiber at one wavelength is multimodal for beams at other wavelengths. This means although the input laser beams (before fiber) can be single mode, the output beams (after fiber) may become multimodal depending on the wavelengths of the beams. This system combines beams using polarization selection as described above.

In Smith et al., U.S. Pat. No. 6,244,712, an improved optical scanning spectroscopic method and apparatus is provided that alternately scans the posterior portion of an eye with laser signals emitted by different ones of a plurality of lasers such that a data frame can be constructed that includes interlaced portions formed from signals returning from the posterior portion of the eye in response to illumination by laser signals emitted by different ones of the plurality of lasers. As such, the same data frame includes data attributable to the reflection of laser signals from each of the plurality of lasers even though the subject's eye is not subjected to simultaneous illumination by each of the lasers, thereby protecting the subject's eye. According to one further aspect of the invention, the optical scanning spectroscopic method and apparatus can illuminate the posterior portion of the subject's eye in response to a trigger at a predetermined point in the cardiac cycle of the subject such that the resulting data frame relates to at least a predetermined portion of the cardiac cycle of the subject, thereby permitting a detailed analysis of one or more phases of the cardiac cycle of the subject.

The Smith et al. '712 patent describes the use of mirrors (which could be dichroic filters or removable mirrors) used for combining different laser beams. A galvanometer is used for scanning the combined beams. In our invention, the galvanometer is used to multiplex different laser beams into one collinear beam.

U.S. Patent Application Publication No. 2005/0147135 of Kurtz et al. discloses an organic vertical cavity laser light producing device comprising a substrate. A plurality of laser emitters emit laser light in a direction orthogonal to the substrate. Each laser emitter within the plurality of laser emitters has a first lateral mode structure in a first axis orthogonal to the laser light direction and has a second lateral mode structure in a second axis orthogonal to both the laser light direction and the first axis. Each laser emitter comprises a first mirror provided on a top surface of the substrate and is reflective to light over a predetermined range of wavelengths. An organic active region produces laser light. A second mirror is provided above the organic active region and is reflective to light over a predetermined range of wavelengths. A pumping means excites the plurality of laser emitters.

The Kurtz et al. '135 publication has a two-dimensional array of VCSELs focused at a spot by a lens. These beams will diverge from the lens just the way they were focused. In other words, the individual beams are not collinearly multiplexed.

In U.S. Patent Application Publication No. 2005/0247683 of Agarwal et al., a material processing system and method is disclosed for processing materials such as amorphous silicon in an annealing processes and lithography processes on a silicon wafer, as well as ablation processes. A first laser generates periodic pulses of radiation along a beam path directed at the target material. Similarly, at least one additional laser generates periodic pulses. A beam aligner redirects the beam path of the at least one additional laser, such that the beam from the at least one additional laser is directed at the target along a path collinear with the first laser's beam path. As a result, all the lasers are directed at the target along the same combined beam path. The periodic pulses of the at least one additional laser are delayed relative to the first laser such that multiple pulses impinge on the target within a single pulse cycle of any given laser.

The Agarwal et al. '683 publication describes combining several pulsed laser beams into a collinear beam path using mirrors which could be dichroic, polarization dependent (Glan-Thompson type) or removable.

Miyazaki, U.S. Pat. No. 5,510,605, discloses a plurality of semiconductor laser diodes disposed so as to emit laser beams whose optical axes extend in different directions. The laser beam emitted from the plurality of semiconductor laser diodes is deflected by a polygon mirror and then reflected by pattern forming mirrors, to thereby form a combined scanning pattern. Although the combined scanning pattern consists of a plurality of cross patterns that are arranged as connected without being overlapped with each other, it actually has the same reading area as a single large cross pattern. Scattered light produced by scanning a bar code symbol by means of the combined scanning pattern is subjected to photoelectric conversion, and a resulting signal is decoded. To form the combined scanning pattern, the rotational angle of the polygon mirror is detected and drives of the plurality of semiconductor laser diodes are switched at high speed based on the detection result.

The Miyazaki '605patent describes several semiconductor laser diode beams being reflected by a single mirror for collinear propagation of all the beams. This is not possible unless the mirror is equipped with a fast angular positioning like a galvanometer and at least there are two independent beam positioning mirrors per laser beam. Both of these are missing in this patent.

In U.S. Pat. No. 6,945,652 to Sakata et al., a light beam having different wavelengths emitted from red and blue semiconductor lasers and a laser diode pumped green solid-state laser are incident on respectively different surfaces of a color combining element and are overlaid on a single light path. Multiple beam interference films of the color combining element allow only the light beams having the oscillating wavelengths corresponding to the respective light sources to pass therethrough or reflect thereon so as to combine the light beams. A collimator collimates the light beams so that the beam waist of the light beams lies around a projection plane. When two-dimensional scanning is performed by radiating the light beams onto a micromechanical mirror and then onto a galvanometer mirror for scanning light in the horizontal and vertical directions, respectively, a color image is displayed on the projection plane by arranging pixels in array, each pixel consisting of overlapping pulses of light of three colors.

The Sakata et al. '652 patent describes combining RGB (Red-Green-Blue) beams via interference filters based on multilayer dielectric coatings (item 14, FIG. 1). Multiplexing of laser beams based on such dichroic beam splitters typically show low R (or T) for narrow band filters. Broad band filters with high throughput cannot be used for combing beams of closely spaced wavelengths. The Sakata et al. system does not allow nearly 100% throughput with no restriction on wavelength separation of individual beams.

In U.S. Pat. No. 6,838,639 to Kreuter et al., where circumstances arise in material machining by means of laser beams, in particular when engraving for example metal or when blackening and marking on plastic material, there is to be provided a process in which in spite of a high frequency of machining pulses the required minimum energy per pulse is achieved. For that purpose a plurality of laser beams are brought together by way of a beam-combining means and passed by way of a common beam-guide means on to the workpiece and in particular operated in time-displaced relationship.

The Kreuter et al. '639 patent describes Glan-Thompson type polarization cubes as beam combiners which results in a dependency upon the polarization of individual beams.

U.S. Pat. No. 6,628,442 to DiFrancesco et al. is directed to a method and apparatus for deflecting a beam using multiple beam scanning galvanometers. One or more embodiments of the invention comprise a system for deflecting an energy beam comprising a first reflective surface for directing an incident beam, a first galvanometer coupled to the first reflective surface for rotating the first reflective surface about a first axis, a second reflective surface for directing the incident beam after directed by the first reflective surface, and a second galvanometer coupled to the second reflective surface for rotating the second reflective surface about a second axis, the second galvanometer positioned remote from the first galvanometer. In one or more embodiments, the system is a part of a laser film recorder. In such an embodiment, the incident beam comprises combined red, green and blue laser beams. The incident beam is directed by the second reflective surface at a film surface.

The DiFrancesco et al. '442 patent describes combining RGB laser beams with the help of a mirror (Red laser) and two dichroic beam splitters (Green & Blue). As shown before, items 116 (Green laser) and 124 (Blue laser) restrict the wavelengths that can be multiplexed collinearly.

U.S. Pat. No. 6,764,183 to Okazaki discloses a color laser display that comprises a red laser light source for emitting red laser light, a green laser light source for emitting green laser light, and a blue laser light source for emitting blue laser light. An excitation solid laser unit (which has a solid-state laser crystal doped with Pr3+ and a GaN semiconductor laser element for exciting the solid-state laser crystal), a fiber laser unit (which has a fiber with a Pr3+-doped core and a GaN semiconductor laser element for exciting the fiber), or a semiconductor laser unit (which has a semiconductor laser element, employing a GaN semiconductor, and a surface-emitting semiconductor element), is employed as at least one of the red laser light source, the green laser light source, or the blue laser light source.

The Okazaki '183 patent describes RGB lasers combined with one mirror (3a) and 2 dichroic beam splitters (3b & 3c).

U.S. Pat. No. 4,979,030 to Murata has a color display apparatus for displaying a color video format signal comprising a two-dimensional screen on which light-beam sensitive three-primary-color luminous bodies are arrayed regularly in a predetermined direction, a generator for generating horizontal and vertical synchronizing signals from the video format signal, a light-beam deflector for scanning the two-dimensional screen with a signal light beam in synchronism with the horizontal and vertical synchronizing signals, and a modulator for modulating the intensity of the light beam in accordance with the color video format signal in synchronism with the scanning of the light beam in the predetermined direction.

The Murata '030patent describes only one laser (and not a plurality of lasers) being scanned by a galvanometer on a screen coated with light sensitive three primary colored (RGB) luminous bodies in arrays.

U.S. Pat. No. 5,485,225 to Deter et al. discloses a video projection system with at least one light source which can be controlled in intensity and generates at least one light bundle and with a deflecting device which deflects the light bundle sequentially to produce picture points of a video picture on a screen by picture and line scanning has two component groups, the first of which contains at least one light source and has a light output from which at least one light bundle exits, while the second component group contains the deflecting device and has a light input through which a light bundle can be imaged into the deflecting device. Further, a light transmission device is provided which enables the light output of the first component group to be optically connected with the light input of the second component group.

The Deter et al. '225 patent describes a three beam (RGB) combiner using three mirrors. This arrangement combines RGB beams via one mirror and two dichroic filters or Glan-Polarizers. The deflection device is not used for multiplexing.

In U.S. Pat. No. 6,606,180 to Harada, light sources of a light beam scanning device are an AlGaInP semiconductor laser emitting a light beam of a wavelength of 680 nm, a GaN extremely small surface area light emitting diode (EELED) emitting a light beam of a wavelength of 530 nm, and a GaN EELED emitting a light beam of a wavelength of 470 nm. Such a structure provides a light beam scanning device which is compact, whose manufacturing cost is low, and with which light beams having light emission distributions corresponding to spectral sensitivities of a photosensitive material.

The Harada '180 patent describes a multiple laser (RGB) scanning device and not a transmission device as in our invention. This patent involves two embodiments that will not allow precise collinear multiplexing of different laser beams as done in our invention. They are: a) cylindrical lenses (40a, 40b and 40c) for correction of pyramidal error in polygon mirror; and b) a pair of independent positioning capability per laser beam for precise co-linearity of multiplexed beams. Precise co-linearity of multiplexed laser beams is an important requirement for many applications requiring such technology.

### SUMMARY OF THE INVENTION

In view of the foregoing disadvantages inherent in the known types of multi-wavelength laser systems now present in the prior art, the present invention provides a system for multiplexing lasers and other optical beams wherein a single end transmission source can provide a selection of optical beams.

The general purpose of the present invention, which will be described subsequently in greater detail, is to provide a system providing a selectable variety of optical and/or laser beams from a single end transmission source which is not anticipated, rendered obvious, suggested, taught, or even implied by any of the prior art multi-wavelength laser systems, either alone or in any combination thereof. One crude analogy for the present invention is a paintbrush that can paint in any color without having to dip it into new paint.

In one embodiment of the present invention, a series of individual lasers are all focused at different angles upon the same axis point of a galvanometer mirror. As the galvanometer mirror rotates, individual ones of the laser beams are brought into alignment with an iris collimator that separates out all the non-selected frequencies while transmitting the aligned frequency. As the individual laser beams may all be available at the same time, rotation of the galvanometer mirror provides almost immediately switching from one wavelength of laser light to another. Consequently, different energies/wavelengths/colors of laser light are available almost immediately and on a contemporaneous basis to the doctor, practitioner, or industrial process to which the multiplex laser system of the present invention is applied. Laser amplitude may also be adjustable.

In an alternative embodiment, the same system can be used to provide multiplexed optical communications for either code division, wavelength division, and/or time division multiplexing. Wavelengths may be transmitted onto detectors specific for each wavelength.

With respect to optical communications, the galvanometer mirror enables the selection of the individual laser wavelengths which are then transmitted to a receiving galvanometer that transfers the incoming beam to a detector of multiple wavelengths or, in coordination with the transmitting galvanometer, transmits the incoming beam to the appropriate detector.

Additionally, the multiplexed optical beam system set forth herein may be used to help detect mixtures of optically active compounds that are responsive to the selected or available laser wavelengths.

The present invention may be used in a variety of applications and may serve to enable and provide operability in many technological areas including: providing and enabling a reverse laser scanning technique for combining a plurality of laser beams into one beam; providing and enabling a galvanometer mirror to be used as the combiner for the plurality of the beams; providing and enabling two (2) independent beam alignment elements per laser beam to combine the plurality of lasers to go through one defined laser beam path; providing and enabling multi-chemical detection using multiple lasers in the same device and in remote sensing; providing and enabling remotely operated laser switching for medical surgery and diagnosis; providing and enabling wavelength, code and time division multiplexing in communication systems; and providing and enabling the routing of optical beams.

In one embodiment of the present invention, a laser system for providing laser light at a plurality of selectable wavelengths includes a first source of first laser light having a first wavelength and a second source of second laser light having a second wavelength. A mirror controllably pivots on an axis with the first and second laser light incident upon the mirror on the axis at respective and different first and second coplanar angles. A collimator is provided that segregatably selects a beam of light. The mirror is selectably adjustable to reflect one of the first and second laser light through the collimator such that the laser system can selectably transmit either the first laser light or the second laser light according to selectable adjustment of the mirror.

In another embodiment of the present invention, a method for providing laser light at multiple wavelengths includes the steps of: focusing laser light of different wavelengths on an axis point of a rotatable reflector or mirror with each of the wavelengths of laser light being co-planar and incident upon the rotatable reflector at respective unique angles; providing a transmission gateway in optical communication with the rotatable reflector, the transmission gateway transmitting a selected wavelength of laser light; and rotating the rotatable reflector to reflect one selected wavelength of the laser light of different wavelengths to the transmission gateway such that multiple wavelengths of laser light are available to and transmittable by the transmission gateway according to rotation of the rotatable reflector.

In yet another embodiment of the present invention, a method for providing laser light at a plurality of selectable wavelengths includes: providing a galvanometer mirror with a central axis about which the galvanometer mirror pivots; and focusing a plurality of laser beams on the axis of the galvanometer mirror, each of the plurality of laser beams being of unique wavelength, being coplanar with one another, and being incident upon the galvanometer mirror at respectively unique angles with each laser beam having its own angle of incidence upon the axis of the galvanometer mirror such that reflection of the laser beams is directionally selectable by rotation of the galvanometer mirror;

Other embodiments of the present invention are set forth in more detail, below, and the embodiments set forth above are made for purposes of example only and not of limitation.

### BRIEF DESCRIPTION OF THE DRAWINGS

FIG. 1 is a diagrammatic view of the laser multiplexing system of the present invention showing a plurality of laser sources with the accompanying mirrors as well as paths of the laser light from the sources to the galvanometer mirror and on to the iris collimator (for the selected beam).

FIG. 2 is a pair of related graphs indicating the detection of NO₂/nitrogen dioxide and SO₂/sulfur dioxide via a system incorporating the present invention.

FIG. 3 is schematic view of a time division multiplexing system with incident laser sources, indications of time domain intervals, and laser light detectors/receivers so that incoming data may be encoded and transmitted for reception as outgoing and received data, respectively.

### BRIEF DESCRIPTION OF THE APPENDICES

The following appendix is incorporated herein by this reference thereto as are the references set forth therein.

Appendix 1is the list of references referred to by the numbers in superscript used throughout this patent.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The masculine pronoun is generally used herein to indicate the generic individual and as a matter of convention and convenience.

Referring to the drawings, where like numerals of reference designate like elements throughout, it will be noted that the present invention resides in a system for providing laser beams of selectable wavelength from a single end transmission source. A selected number of laser light sources are brought to bear in a co-planar fashion on a single axis point of a galvanometer mirror. Each of the laser beams will reflect from the point at a different angle thereby giving a spectrum of available wavelengths due to the turning of the galvanometer and the accompanying mirror. By judiciously and selectably adjusting the angle of the galvanometer mirror, a certain beam is caused to pass through a set of collimating irises which then enables the selected beam to be transmitted on to the end transmission source by fiber optics or otherwise. In this way, a single installation of multi-wavelength laser light can provide selectable frequencies for the end user(s). Such a single installation is contemplated as possibly supplying several termini.

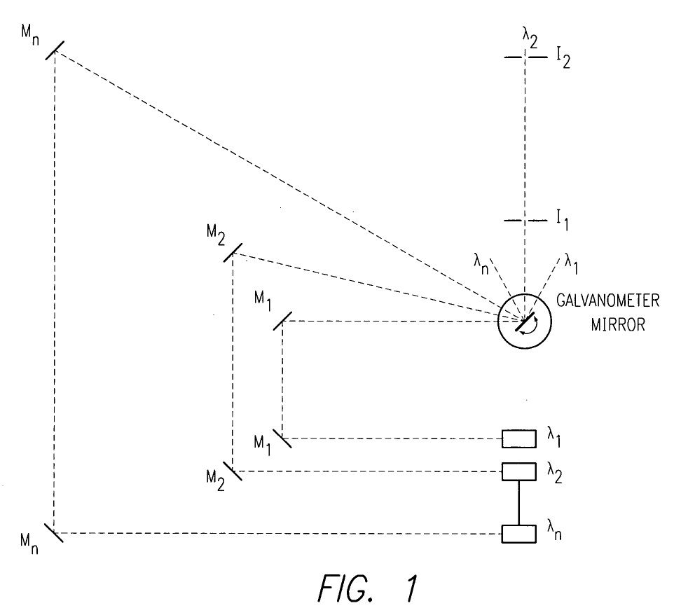

Laser scanning is a technology where a laser beam is scanned angularly (as for bar codes, imaging etc.) using mirrors controlled by galvanometers. In a “path reversal” of this process, laser beams are aligned angularly along different scanned beam paths to meet at a point on the galvanometer. After reflection and single axis angle tuning of the galvanometer, the laser beams are switched and redirected along one optical path. A schematic is shown in FIG. 1. A number, n, of laser beams of wavelengths λ₁, λ₂, . . . , λₙ, are aligned angularly to meet at the same point on the galvanometer This meeting point of the laser beams lies on the rotation axis of the galvanometer which causes the beams to all reflect from a single point although each beam may reflect at a unique angle. If this were not the case, there would be different and undesirable rotations and translations of the reflected individual laser beams. Also, the beams from all the lasers preferably lie in one plane, maintaining the same beam height throughout. A sweep angle θ of the galvanometer mirror results in a sweep of each reflected laser beam by 2θ per the known law of reflection. Through careful programming and angular calibration, the galvanometer mirror may be selectably controlled to turn at the precise angles θ₁, θ₂, . . . θₙ, to align the laser beams of wavelengths λ₁, λ₂, . . . , λₙ, along a single optical path. The multiplexed beam path is defined by a pair of irises I₁, and I₂. Mirrors M₁, M₁′, M₂, M₂′, . . . , Mₙ, Mₙ′ are the pairs of mirrors designated for the alignment of lasers beams λ₁, λ₂, . . . , λₙ independently through irises I₁, and I₂ after reflection from the galvanometer mirror. The insertion loss in this multiplexing scheme is preferably practically zero, generally only limited by the reflectivity of the mirror on the galvanometer. To ensure maximum and/or optimum output at a selected wavelength, detection circuitry may be used to determine the output amplitude for a selected wavelength.

As used herein, the term “mirror” indicates a wave/wavefront reflector of any wave phenomenon, especially optical and/or electromagnetic waves.

In one installation for the sampling of gases, a galvanometer (GSI Lumonics model VM500C) and its servo driver (MiniSAX servo) were used. The scanner was temperature controlled to within +/−0.5° C. of the regulation set point (30° C. to 50° C.). With a capacitive position feedback, the repeatability of the angular position is within 10 μradians. The galvanometer was optimized for position accuracy but not speed with typical step times of approximately 250 μs. The maximum scan angle of the optical beam was approximately ±30°. The command voltage from the computer to the servo driver was ±3V for full scale with 12 bit resolution. A Linux operating system and the appropriate drivers were used for accurate control of the galvanometer angle.

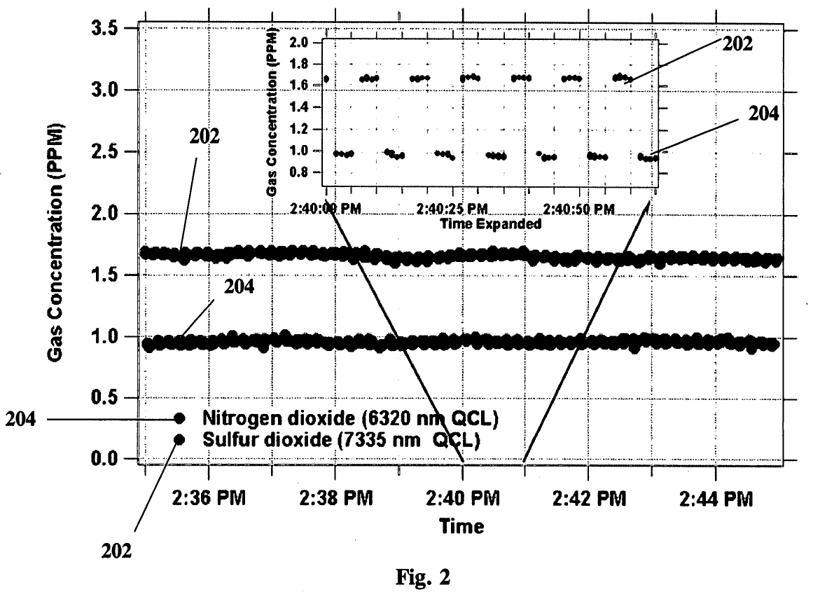

Two quantum cascade lasers were used, one tuned to 6.3 μm wavelength for NO₂ detection and the other 7.3 μm wavelength for SO₂ detection. The two gases were mixed at known concentrations and optically sampled in a photoacoustic gas cell for laser photo-acoustic detection⁷. The two laser beams (having typical CW power of 100 mW) were multiplexed along a similar optical beam path as shown in FIG. 1 through the photoacoustic cell. The experimental result of the optically multiplexed detection of 1.7 ppm (parts-per-million) SO₂ 202 and 0.9 ppm NO₂ 204 at five second time intervals is shown in FIG. 2.

The present system (FIG. 1) may be used in conjunction with optical communications. A combination of wavelength-division multiplexing and time spread code-division multiplexing has been proposed for high security optical communication⁸. The time spreading as proposed can be done by fixed fiber-optic delay lines that are different for different wavelength channels (lasers). The fixed optical delay lines for different wavelength channels are identical for the transmitter as well as the receiver. The delay lines however are fixed and can be potentially decoded. The present system may provide a communication scheme with a higher level security.

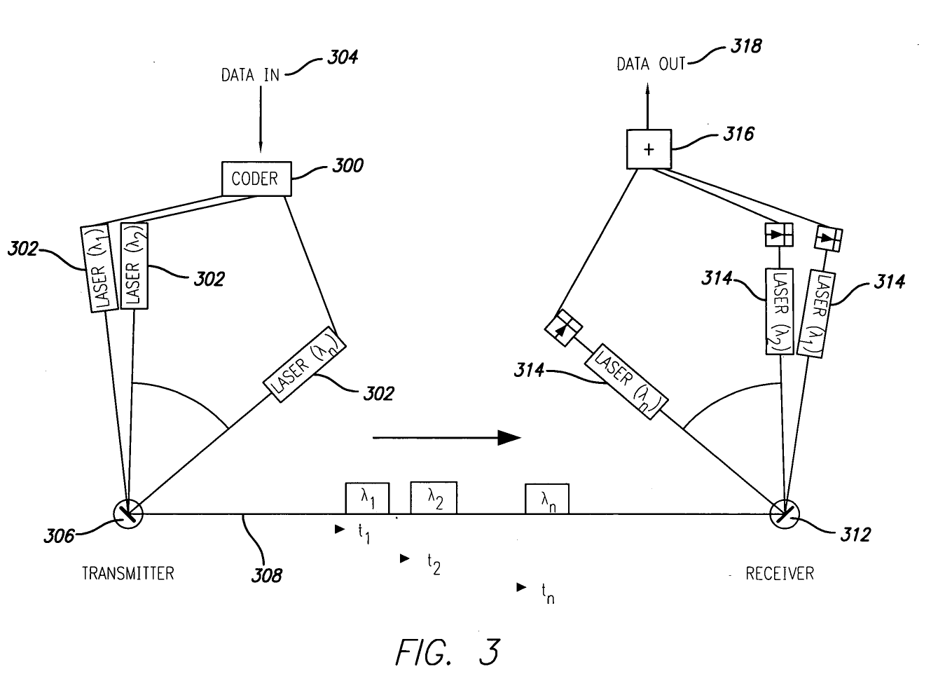

The instrumentation and the associated software as mentioned above may serve as an alternate platform for optical communication where code division, wavelength division as well as time division multiplexing can be done by the same unit. Here the “time-spread” between wavelength channels is not fixed and full scale time division multiplexing (TDM) can be performed. The program for TDM as performed by the galvanometer is identical for the transmitter and receiver. The scheme of such a communication system either free-space or fiber optic is shown in FIG. 3. A conventional coding mechanism 300 codes the individual lasers 302λ₁, 302_{λ2}, . . . , 302_{λn} in each wavelength channel according to the incoming data 304. As mentioned before, a large number of lasers (preferably in scalable arrangement) can be wavelength multiplexed through the present non-dispersive optical multiplexer. The adjustable delays between the wavelength channels are achieved by appropriately programming the transmitting galvanometer 306 as described above. The resulting time divided multifrequency beam 308 has separate time domains as indicated by the blocks/segments λ₁, λ₂, . . . , λₙ that respectively correspond to time domains t₁, t₂, . . . , tₙ. The coordination of angular position of the transmitting and receiving galvanometers maybe achieved by (1) a separate communication channel, (2) an agreed upon schedule or (3) an embedded protocol as a part of the optical communication between the overall transmitting and receiving systems.

Beam 308 is then transmitted to the receiving galvanometer 312 where the particular wavelengths are transmitted onto detectors sensitive to each wavelength. Detectors 314_{λ1}, 314_{λ2}, . . . , 314_{λn} attached to each wavelength channel send the data to the decoder 316 and data is taken out 318. This one unit transmitter and one unit receiver is generally scalable in cascade fashion because of the very low transmission losses through the multiplexer arising from better than 99.9% reflectivity achievable for mirrors. That is, multiplexed laser beams of one unit can serve as one channel for a higher level multiplexing of another unit. In other words, each wavelength channel of one higher level multiplexer is actually multiplexed beams of one lower level multiplexer. This way any number of multiplexing units can be cascaded for ultra high connectivity applications. The receiver end will also have to be similarly cascaded as the transmitter.

This scheme can be used in fiber-optic or free-space communication. In fiber-optic communication, the multiplexed beams can be conveniently coupled in and out of a fiber at the transmitter and receiver ends. In free-space communication, an adaptive optical element⁹ like a deformable mirror can be used in the multiplexed beam at the transmitter end and a wave-front sensor and reconstructor at the receiver end to partially get rid of wavefront distortion due to atmospheric turbulence.

These and other advantages, utilities, applications, and solutions provided by the present invention will be apparent from a review of the specification herein and accompanying drawings. The foregoing are some of but a few of the goals sought to be attained by the present invention and are set forth for the purposes of example only and not those of limitation.

While the present invention has been described with regards to particular embodiments, it is recognized that additional variations of the present invention may be devised without departing from the inventive concept.

### APPENDIX

References:

1. W. J. Tomlinson, “Wavelength Multiplexing in Multimode Optical Fibers,” Applied Optics, Vol. 16, No. 8, 2180-2194, August 1977.

2. H. R. Stuart, “Dispersive Multiplexing in Multimode Optical Fiber,” Science, Vol. 289, no. 5477, pp 281-283, 14 July, 2000.

3. C. A. Bracken “Dense Wavelength Division Multiplexing Networks: Principles and Applications,” IEEE Jour. On Selected Areas in Communications, Vol. 8, Issue 6, 948-964, August 1990.

4. A. S. Kewitsch, G. A. Rakuljic, P. A. Willems and A. Yariv. “All-Fiber Zero-Insertion-Loss Add-Drop Filter for Wavelength-Division Multiplexing,” Optics Letters, Vol. 23, NO. 2, 106-108, January 1998.

5. K. Ken-ichi, S. Hideyuki, W. Naoya, “Optical Code Division Multiplexing (OCDM) and its Applications to Photonic Networks,” IFICE Transactions on Fundamentals of Electronics, Communications and Computer Sciences, Vol. E82-A, No. 12 2616-262, December 1999.

6. G. Cincotti, M. S. Moreolo and A. Neri, “All-Optical Multiplexing Schemes for Multiple Access Networks Based on Wavelet Packet Filter Banks,” Integrated Optics and Photonic Integrated Circuits, G. Righini and S. Honkanen, Eds, Proceedings of SPIE, Vol. 5451, pp. 475-486, August 2004.

7. Michael E. Webber, Michael Pushkarsky, Kumar Patel, “Optical Detection of Chemical Warfare Agents and Toxic Industrial Chemicals: Simulation,” Journal of Applied Physics 97, 113101 (2005)

8. D. B. Rafol and K. Wilson. “Laser-based Adaptive Wavelength Division Multiplexing for Free-Space Optical Communication,” Jet Propulsion Laboratory New Technology Report NPO—20890, 1 April, 2002 NASA Tech Brief Vol. 26, No. 4.

9. T. Weyrauch, M. A. Vorontsov, J. W. Gowens II, T. G. Bifano, “Fiber Coupling with Adaptive Optics for Free-Space Communication,” Proceedings of SPIE Vol. 4489, 177, 2002.

What is claimed is:

1. A laser system for providing laser light at a plurality of selectable wavelengths, comprising:
a bank of laser light sources, said bank providing a spectrum of laser light from infrared to visible to ultraviolet, said bank having a first source of first laser light having a first wavelength and a second source of second laser light having a second wavelength;
a mirror controllably pivoting on an axis;
each of said sources of laser light in said bank having a unique wavelength and a unique coplanar angle of incidence upon said mirror on said axis including said first and second laser light;
a collimator for selecting a beam of light; and
said collimator having at least two irises through which laser light reflected by said mirror selectably passes; whereby
said mirror selectably adjustable to reflect one of said first and second laser light through said collimator such that the laser system can selectably transmit either said first laser light or said second laser light according to selectable adjustment of said mirror.

2. A system incorporating the laser system for providing laser light at a plurality of selectable wavelengths as set forth in claim 1, the incorporating system selected from the group consisting of multi-chemical detection systems, remote sensing systems, remotely operated laser switching systems for medical, surgical, and diagnostic purposes, wavelength division multiplexed communication systems, code division multiplexed communication systems, time division multiplexed communication systems, optical beam routing systems, and combinations thereof.

3. A method for providing laser light at multiple wavelengths, the steps comprising:
focusing laser light of different wavelengths on an axis point of a rotatable mirror, each of said wavelengths of laser light being co-planar and incident upon said rotatable mirror at respective unique angles, said focusing of laser light of different wavelengths including providing laser light of said different wavelengths and reflecting said wavelengths by mirrors individually associated with each wavelength so that said wavelengths are co-planar and each are incident upon said rotatable mirror at said respective unique angles;
providing a transmission gateway in optical communication with said rotatable mirror, said transmission gateway transmitting a selected wavelength of laser light, said transmission gateway including an iris collimator which segregates for transmission said selected wavelength of laser light, said iris collimator having at least two aligned irises through which said selected wavelength of laser light passes for transmission by said transmission gateway; and
rotating said rotatable mirror to reflect one selected wavelength of said laser light of different wavelengths to said transmission gateway, said rotatable mirror rotated by a signal-responsive galvanometer that rotates said rotatable mirror according to a signal; whereby
said multiple wavelengths of laser light are available to and transmittable by said transmission gateway according to rotation of said rotatable mirror.

4. A method for providing laser light at a plurality of selectable wavelengths, comprising:
providing a galvanometer mirror, said galvanometer mirror having a central axis about which said galvanometer mirror pivots; and
focusing a plurality of laser beams on said axis of said galvanometer mirror, each of said plurality of laser beams being of unique wavelength, being coplanar with one another, and being incident upon said galvanometer mirror at respectively unique angles with each laser beam having its own angle of incidence upon said axis of said galvanometer mirror; whereby
reflection of said laser beams is directionally selectable by rotation of said galvanometer mirror.

5. A laser system for providing laser light at a plurality of selectable wavelengths, comprising:
a first source of first laser light having a first wavelength;
a second source of second laser light having a second wavelength;
a mirror controllably pivoting on an axis;
said first and second laser light incident upon said mirror on said axis at respective and different first and second coplanar angles;
a collimator for segregatably selecting a beam of light; and
said mirror selectably adjustable to reflect one of said first and second laser light through said collimator; whereby
the laser system can selectably transmit either said first laser light or said second laser light according to selectable adjustment of said mirror.

6. A laser system for providing laser light at a plurality of selectable wavelengths as set forth in claim 5, further comprising:
said first laser light reflected to said mirror by a first pair of beam alignment elements, said first pair of beam alignment elements being independently operable; and
said second laser light reflected to said mirror by a second pair of beam alignment elements, said second pair of beam alignment elements being independently operable.

7. A laser system for providing laser light at a plurality of selectable wavelengths as set forth in claim 6, further comprising:
said beam alignment elements of said first and second pairs of beam alignment elements being mirrors.

8. A laser system for providing laser light at a plurality of selectable wavelengths as set forth in claim 5, further comprising:
said first and second sources of laser light are two sources of laser light in a bank of laser light sources, each of said sources of laser light in said bank having a unique wavelength and a unique coplanar angle of incidence upon said mirror on said axis.

9. A laser system for providing laser light at a plurality of selectable wavelengths as set forth in claim 8, further comprising:
said bank of laser light sources providing a spectrum of laser light from infrared to visible to ultraviolet.

10. A laser system for providing laser light at a plurality of selectable wavelengths as set forth in claim 8, further comprising:
said collimator having at least two irises through which laser light reflected by said mirror selectably passes.

11. A system incorporating the laser system for providing laser light at a plurality of selectable wavelengths as set forth in claim 5, the incorporating system selected from the group consisting of multi-chemical detection systems, remote sensing systems, remotely operated laser switching systems for medical, surgical, and diagnostic purposes, wavelength division multiplexed communication systems, code division multiplexed communication systems, time division multiplexed communication systems, optical beam routing systems, and combinations thereof.

12. A method for providing laser light at multiple wavelengths, the steps comprising:
focusing laser light of different wavelengths on an axis point of a rotatable reflector, each of said wavelengths of laser light being co-planar and incident upon said rotatable reflector at respective unique angles;
providing a transmission gateway in optical communication with said rotatable reflector, said transmission gateway transmitting a selected wavelength of laser light; and
rotating said rotatable reflector to reflect one selected wavelength of said laser light of different wavelengths to said transmission gateway; whereby
multiple wavelengths of laser light are available to and transmittable by said transmission gateway according to rotation of said rotatable reflector.

13. A method for providing laser light at multiple wavelengths as set forth in claim 12, wherein said step of focusing laser light of different wavelengths further comprises:
providing laser light of said different wavelengths and reflecting said wavelengths by reflectors individually associated with each wavelength so that said wavelengths are co-planar and each are incident upon said rotatable reflector at said respective unique angles.

14. A method for providing laser light at multiple wavelengths as set forth in claim 12, wherein said step of providing a transmission gateway further comprises:
providing an collimator which segregates for transmission said selected wavelength of laser light.

15. A method for providing laser light at multiple wavelengths as set forth in claim 14, wherein said step of providing a transmission gateway further comprises:
providing an iris collimator having at least two aligned irises through which said selected wavelength of laser light passes for transmission by said transmission gateway.

16. A method for providing laser light at multiple wavelengths as set forth in claim 12, wherein said step of rotating said rotatable reflector further comprises:
providing an signal-responsive actuator that rotates said rotatable reflector according to a signal.

17. A method for providing laser light at multiple wavelengths as set forth in claim 12, wherein said step of providing an signal-responsive actuator further comprises:
providing a galvanometer coupled to said rotatable reflector.
